(19) United States
(12) Patent Application Publication
(10) Pub. No.: US 2025/0133316 A1
(43) Pub. Date: Apr. 24, 2025

(54) VEHICLE AND CAR SEAT COMPRISING A LOW FREQUENCY SPEAKER

(71) Applicant: Harman Becker Automotive Systems GmbH, Karlsbad (DE)

(72) Inventor: Daniel BRACHT, Karlsruhe (DE)

(73) Assignee: Harman Becker Automotive Systems GmbH, Karlsbad (DE)

(21) Appl. No.: 18/922,006

(22) Filed: Oct. 21, 2024

(30) Foreign Application Priority Data
Oct. 19, 2023 (DE) 10 2023 128 781.8

(51) Int. Cl. H04R 1/02; B60N 2/50

(52) U.S. Cl. CPC H04R 1/025; B60N 2/503; H04R 2499/13

(57) ABSTRACT

A vehicle comprises a car seat comprising a seating area and a backrest, wherein the seating area is arranged at a lower end of the backrest, and a low frequency speaker configured to emit sound at frequencies of between 20 Hz and 200 Hz, wherein the backrest comprises a rigid frame, a flexible suspension system, and upholstery, wherein the suspension system is suspended in the frame and covered by the upholstery such that, when an occupant of the vehicle is seated on the car seat, at least a portion of the upholstery is arranged between the suspension system and the occupant. The low frequency speaker is arranged in the backrest and attached to the suspension system, wherein the low frequency speaker is arranged on a backside of the suspension system that faces away from the seating area.

### CROSS-REFERENCE TO RELATED APPLICATIONS

This application claims priority to DE application Serial No. 102023128781.8 filed Oct. 19, 2023, the disclosure of which is hereby incorporated in its entirety by reference herein.

### TECHNICAL FIELD

The disclosure relates to a vehicle and a car seat comprising a low frequency speaker.

### BACKGROUND

Integration of speakers in a vehicle may be challenging. When integrating a speaker into a vehicle, many different aspects and constraints have to be considered. During the use of the speaker, the speaker may cause other elements of the vehicle to vibrate, thereby generating unwanted noise that adversely affect the listening experience of the occupants. Further, vibrations may be transmitted from the speaker via other elements of the vehicle to an occupant of the user. Such haptically perceived vibrations may be perceived as unpleasant by an occupant. It is, however, also possible to favorably use the vibrations to provide structure-borne sound to the occupant which can increase the overall listening experience. In order to be perceived as pleasant by an occupant, however, structure-borne sound generally needs to be well tuned. Even further, the acoustic performance of the speaker may suffer if a speaker is positioned in an unfavorable position. Loudspeakers that are arranged to provide an enhanced acoustic performance as well as structure-borne sound require a certain amount of space, which is usually a critical aspect in a vehicle.

There is a need for a vehicle comprising a low frequency speaker that is easily integrable, requires only little additional space, and provides a satisfying listening experience for an occupant of the vehicle.

### SUMMARY

A vehicle includes a car seat including a seating area and a backrest, wherein the seating area is arranged at a lower end of the backrest. The vehicle further includes a low frequency speaker configured to emit sound at frequencies of between 20 Hz and 200 Hz. The backrest includes a rigid frame, a flexible suspension system, and upholstery, wherein the suspension system is suspended in the frame and covered by the upholstery such that, when an occupant of the vehicle is seated on the car seat, at least a portion of the upholstery is arranged between the suspension system and the occupant. The low frequency speaker is arranged in the backrest and attached to the suspension system, wherein the low frequency speaker is arranged on a backside of the suspension system that faces away from the seating area.

A car seat includes a seating area and a backrest, wherein the seating area is arranged at a lower end of the backrest. The car seat further includes a low frequency speaker configured to emit sound at frequencies of between 20 Hz and 200 Hz. The backrest includes a rigid frame, a flexible suspension system, and upholstery, wherein the suspension system is suspended in the frame and covered by the upholstery such that, when an occupant is seated on the car seat, at least a portion of the upholstery is arranged between the suspension system and the occupant. The low frequency speaker is arranged in the backrest and attached to the suspension system, wherein the low frequency speaker is arranged on a backside of the suspension system that faces away from the seating area.

Other systems, features and advantages of the disclosure will be or will become apparent to one with skill in the art upon examination of the following detailed description and figures. It is intended that all such additional systems, methods, features and advantages included within this description, be within the scope of the invention and be protected by the following claims.

### BRIEF DESCRIPTION OF THE DRAWINGS

The method may be better understood with reference to the following description and drawings. The components in the figures are not necessarily to scale, emphasis instead being placed upon illustrating the principles of the invention. Moreover, in the figures, like referenced numerals designate corresponding parts throughout the different views.

FIG. 1 schematically illustrates a top view of a vehicle according to embodiments of the disclosure.

FIG. 2 schematically illustrates a three-dimensional view of a car seat and a low frequency speaker.

FIG. 3 schematically illustrates a three-dimensional view of a car seat according to embodiments of the disclosure.

FIG. 4 schematically illustrates a cross-sectional view of a car seat according to embodiments of the disclosure.

### DETAILED DESCRIPTION

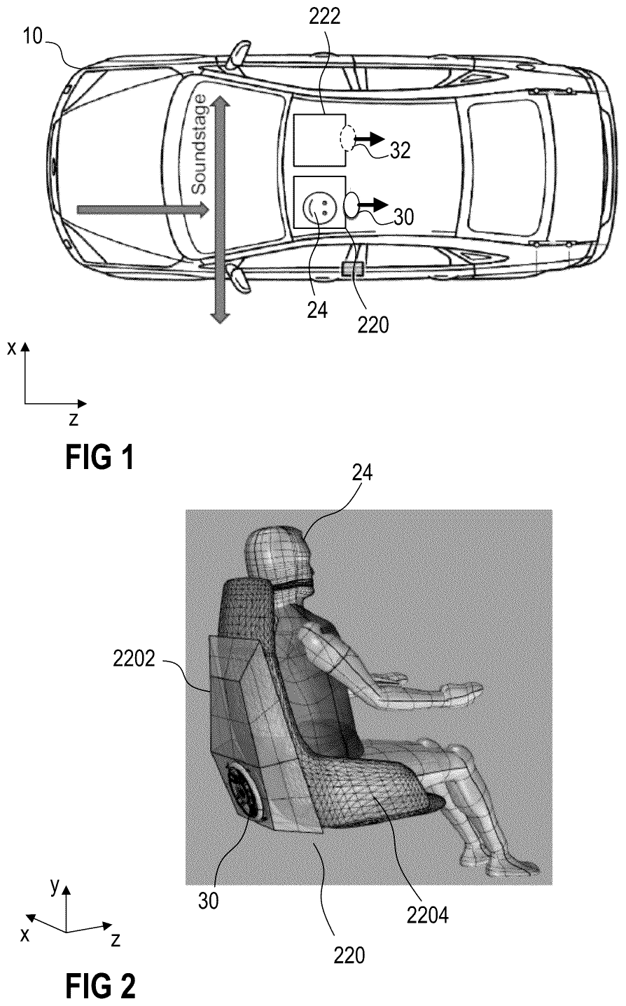

FIG. 1 schematically illustrates a top view of a vehicle 10. The vehicle comprises a car seat 220 (e.g., a driver's seat). A car seat 220 generally comprises a seating area and a backrest. A low frequency speaker 30 is arranged in the backrest of the car seat 220. The low frequency speaker 30 is configured to emit sound at frequencies of between 20 Hz and 200 Hz. The low frequency speaker 30 is arranged at a backside of the car seat 220. That is, a sound radiating surface of the low frequency speaker 30 may be directed towards the back of the vehicle 10. In other words, a main direction of sound propagation may be directed towards the rear of the vehicle 10 (indicated by an arrow in FIG. 1). Low frequency sound waves, however, generally propagate in all directions (spherical wave).

The position of the low frequency speaker 30 is described in more detail with respect to FIG. 2 in the following. FIG. 2 schematically illustrates a car seat 220, for example, a driver's seat, comprising a seating area 2204 and a backrest 2202. The seating area 2204 is arranged at a lower end of the backrest 2202. The lower end of a backrest 2202 in a vehicle generally is an end facing towards a ground surface (i.e. towards a road the vehicle 10 is travelling on). The low frequency speaker 30 is arranged in the backrest 2202, in particular on a backside of the backrest 2202 that faces away from the seating area 2204 and is therefore configured to emit sound (main direction of sound propagation) mainly in a direction facing away from the seating area 2204. That is, the low frequency speaker 30 (e.g., a sound radiating surface of the low frequency speaker 30) is directed towards one or more back seats arranged behind the respective car seat 220. Positioning a low frequency speaker 30 in a backrest 2202 of a car seat 220 such that it is directed towards the back of the vehicle 10 (away from the seating area 2204 of the car seat 220 it is mounted in) results in an optimized low frequency output (SPL), bandwidth and localization, for example. It is further possible to optimize the vibration (tactile feedback) of the low frequency speaker 30 in this position, which will be described in more detail below.

The low frequency speaker 30 may be mechanically coupled to the car seat 220 such that an occupant 24 of the vehicle 10 perceives vibrations generated by the low frequency speaker 30. This effect is also used, for example, in cinemas to enhance the perception of the sound (so-called shaker effect) and may also be referred to as structure-borne sound. An occupant 24 seated on the car seat 220 may fully immerse in the sound (bass) generated by the low frequency speaker 30 such that the sound experience may be enhanced.

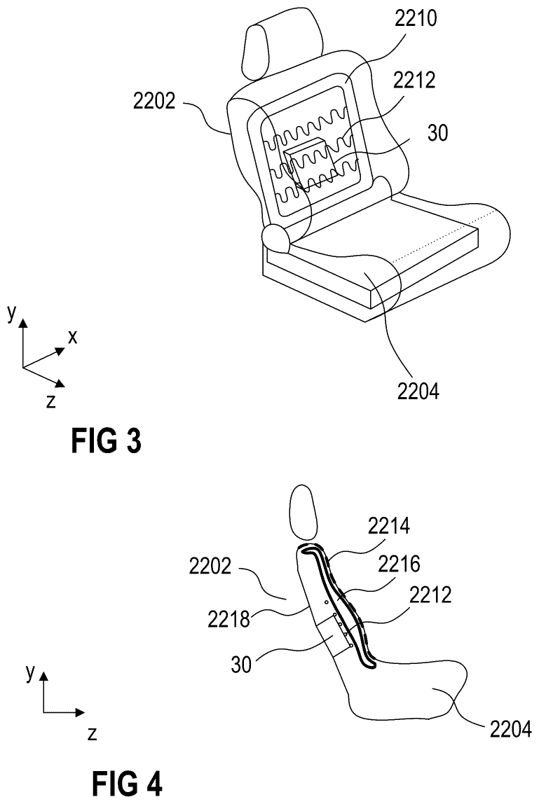

Referring to FIG. 3 a three-dimensional view of a car seat according to embodiments of the disclosure is schematically illustrated. FIG. 4 schematically illustrates a cross-sectional view of a car seat according to embodiments of the disclosure. A car seat 220 generally comprises a rigid frame 2210, usually a metal frame, which is covered by foam, cushion or upholstery. The frame 2210 and upholstery 2216 generally define the seating area 2204 and the backrest 2202 of the car seat 220. The upholstery 2216 may be further covered by a layer of fabric 2214, for example, as is schematically illustrated in FIG. 4. Different components such as, for example, belt receptables, reclining mechanism, etc. may be mounted to the frame 2210, for example. The car seat 220 (i.e. the backrest 2202 of the car seat 220) further comprises a flexible suspension system 2212. The flexible suspension system 2212 may comprise at least one spring element, for example, a metal spring element, or may comprise woven fabric. Generally, flexible suspension systems can be implemented in many different ways. The suspension system 2212 is suspended in the frame 2210 and covered by the upholstery 2216 such that, when an occupant of the vehicle 10 is seated on the car seat 220, at least a portion of the upholstery 2216 is arranged between the suspension system 2212 and the occupant (see FIG. 4). In FIG. 4, only a portion of the upholstery 2216 arranged between the suspension system 2212 and an occupant of the vehicle (occupant not specifically illustrated) is specifically emphasized. The frame 2210 may comprise backrest side members, for example, that are arranged along the sides (left and right) of the backrest 2202. For example, the suspension system 2212 may be mechanically coupled between the backrest side members. As is illustrated in the figures, the speaker 30 is attached to the suspension system 2212.

The flexible suspension system 2212 is in a rest position when no occupant is seated on the car seat 220. When an occupant is seated on the car seat 220 and leans against the backrest 2202, the upholstery 2216, due to the weight of the occupant, is pushed against the suspension system 2212. The suspension system 2212 yields under the weight of the occupant and moves out of a resting position thereof. The suspension system 2212 may have a defined spring stiffness such that the suspension system 212 provides a certain mechanical stability, while still being flexible to a certain degree. In order to allow the suspension system 2212 to move out of a resting position thereof, the backrest 2202 may comprise a cavity adjacent to the suspension system 2212 towards the back side 2218 of the car seat 220 (the back side 2218 of the car seat facing towards the back of the vehicle 10). That is, the suspension system 2212 can move freely towards the back side 2218 of the car seat 220.

The speaker 30, when attached to the suspension system 2212, may at least partly be arranged in this cavity between the suspension system 2212 and a backside 2218 of the backrest 2202. In this way, the speaker 30 requires no or only little additional space in the vehicle 10. That is, the speaker 30 does not or does only slightly protrude from the backside of the backrest 2202. The backside of the backrest 2202 in this way can be essentially flat such that foot space for a passenger seated behind the car seat 220 is as large as possible. A speaker sticking out (protruding from) a backside of the backrest 2202 would take up space within the foot space which may be annoying and uncomfortable for a passenger seated behind the car seat 220, as the passenger's knees or lower legs, for example, could bump into the speaker 30 when the passenger moves. This is not the case when the speaker is fully or almost entirely arranged in the cavity within the backrest 2202. As the speaker 30 is attached to the suspension system 2212, the speaker 30 moves together with the suspension system 2212 when an occupant is seated on the car seat 220. On the other hand, when the speaker 30 vibrates while in use, such vibrations are transferred to the suspension system 2212 and from there to the upholstery 2216 and can be perceived by the occupant seated on the car seat 220. That is, by attaching the speaker 30 to the suspension system 2212, it is generally also possible to provide tactile feedback for an occupant seated on the respective car seat 220, while requiring no or only little additional space in the vehicle 10. The speaker 30 may be attached to the suspension system 2212 in any suitable way, for example, by way of any suitable mounting mechanism. The speaker 30 may comprise a loudspeaker enclosure, and the loudspeaker enclosure may be attached to the suspension mechanism 2212. That is, a mounting mechanism may be connected to the loudspeaker enclosure and to the suspension system 2212, thereby attaching the speaker 30 to the suspension system 2212.

A vehicle 10 according to embodiments of the disclosure comprises a car seat 220 comprising a seating area 2204 and a backrest 2202, wherein the seating area 2204 is arranged at a lower end of the backrest 2202. The vehicle 10 further comprises a low frequency speaker 30 configured to emit sound at frequencies of between 20 Hz and 200 Hz. The backrest 2202 comprises a rigid frame 2210, a flexible suspension system 2212, and upholstery 2216, wherein the suspension system 2212 is suspended in the frame 2210 and covered by the upholstery 2216 such that, when an occupant of the vehicle 10 is seated on the car seat 220, at least a portion of the upholstery 2216 is arranged between the suspension system 2212 and the occupant. The low frequency speaker 30 is arranged in the backrest 2202 and attached to the suspension system 2212, and the low frequency speaker 30 is arranged on a backside of the suspension system 2212 that faces away from the seating area 2204.

The suspension system 2212 may comprise at least one spring element. Alternatively or additionally, the low frequency speaker 30 may comprise a loudspeaker enclosure, wherein the loudspeaker enclosure is attached to the suspension system 2212. Additionally or alternatively, the backrest 2202 may comprise a cavity adjacent to the suspension system 2212 towards a back side 2218 of the car seat 220, wherein the low frequency speaker 30 is at least partly arranged in the cavity between the suspension system 2212 and a backside 2218 of the backrest 2202.

The car seat 220 may be a driver's seat. The vehicle may further comprise a front passenger seat 222 comprising a seating area 2204 and a backrest 2202, wherein the seating area 2204 is arranged at a lower end of the backrest 2202. The vehicle 10 may further comprise a second low frequency speaker 32 configured to emit sound at frequencies of between 20 Hz and 200 Hz. The backrest 2202 off the front passenger seat 222, similar to the driver's seat 220, may comprise a rigid frame 2210, a flexible suspension system 2212, and upholstery 2216, wherein the suspension system 2212 is suspended in the frame 2210 and covered by the upholstery 2216 such that, when an occupant of the vehicle 10 is seated on the front passenger seat 222, at least a portion of the upholstery 2216 is arranged between the suspension system 2212 and the occupant. The second low frequency speaker 32 is arranged in the backrest 2202 and attached to the suspension system 2212, and the second low frequency speaker 32 is arranged on a backside of the suspension system 2212 that faces away from the seating area 2204.

A car seat 220 according to embodiments of the disclosure comprises a seating area 2204 and a backrest 2202, wherein the seating area 2204 is arranged at a lower end of the backrest 2202. The car seat 220 further comprises a low frequency speaker 30 configured to emit sound at frequencies of between 20 Hz and 200 Hz. The backrest 2202 comprises a rigid frame 2210, a flexible suspension system 2212, and upholstery 2216, wherein the suspension system 2212 is suspended in the frame 2210 and covered by the upholstery 2216 such that, when an occupant is seated on the car seat 220, at least a portion of the upholstery 2216 is arranged between the suspension system 2212 and the occupant. The low frequency speaker 30 is arranged in the backrest 2202 and attached to the suspension system 2212, and the low frequency speaker 30 is arranged on a backside of the suspension system 2212 that faces away from the seating area 2204.

It may be understood, that the illustrated systems are merely examples. While various embodiments of the invention have been described, it will be apparent to those of ordinary skill in the art that many more embodiments and implementations are possible within the scope of the invention. In particular, the skilled person will recognize the interchangeability of various features from different embodiments. Although these techniques and systems have been disclosed in the context of certain embodiments and examples, it will be understood that these techniques and systems may be extended beyond the specifically disclosed embodiments to other embodiments and/or uses and obvious modifications thereof. Accordingly, the invention is not to be restricted except in light of the attached claims and their equivalents.

The description of embodiments has been presented for purposes of illustration and description. Suitable modifications and variations to the embodiments may be performed in light of the above description or may be acquired from practicing the methods. The described arrangements are exemplary in nature, and may include additional elements and/or omit elements. As used in this application, an element recited in the singular and proceeded with the word “a” or “an” should be understood as not excluding plural of said elements, unless such exclusion is stated. Furthermore, references to “one embodiment” or “one example” of the present disclosure are not intended to be interpreted as excluding the existence of additional embodiments that also incorporate the recited features. The terms “first,” “second,” and “third,” etc. are used merely as labels, and are not intended to impose numerical requirements or a particular positional order on their objects. The described systems are exemplary in nature and may include additional elements and/or omit elements. The subject matter of the present disclosure includes all novel and non-obvious combinations and sub-combinations of the various systems and configurations, and other features, functions, and/or properties disclosed. The following claims particularly point out subject matter from the above disclosure that is regarded as novel and non-obvious.

What is claimed is:

1. A vehicle comprising:
a car seat comprising a seating area and a backrest, wherein the seating area is arranged at a lower end of the backrest; and
a low frequency speaker configured to emit sound at frequencies of between 20 Hz and 200 Hz, wherein
the backrest comprising a rigid frame, a flexible suspension system, and upholstery, wherein the suspension system is suspended in the frame and covered by the upholstery such that, when an occupant of the vehicle is seated on the car seat, at least a portion of the upholstery is arranged between the suspension system and the occupant,
the low frequency speaker is arranged in the backrest and attached to the suspension system, and
the low frequency speaker is arranged on a backside of the suspension system that faces away from the seating area.

2. The vehicle of claim 1, wherein the suspension system comprises at least one spring element.

3. The vehicle of claim 1, wherein the low frequency speaker comprises a loudspeaker enclosure, and wherein the loudspeaker enclosure is attached to the suspension system.

4. The vehicle of claim 1, wherein the backrest comprises a cavity adjacent to the suspension system towards a back side of the car seat, and wherein the low frequency speaker is at least partly arranged in the cavity between the suspension system and a backside of the backrest.

5. The vehicle of claim 1, wherein the car seat is a driver's seat.

6. The vehicle of claim 5, further comprising:
a front passenger seat including a seating area and a backrest, wherein the seating area is arranged at a lower end of the backrest; and
a second low frequency speaker configured to emit sound at frequencies of between 20 Hz and 200 Hz, wherein
the backrest comprises a rigid frame, a flexible suspension system, and upholstery, wherein the suspension system is suspended in the frame and covered by the upholstery such that, when an occupant of the vehicle is seated on the car seat, at least a portion of the upholstery is arranged between the suspension system and the occupant,
the second low frequency speaker is arranged in the backrest and attached to the suspension system, and
the second low frequency speaker is arranged on a backside of the suspension system that faces away from the seating area.

7. A car seat comprising:
a seating area and a backrest, wherein the seating area is arranged at a lower end of the backrest; and
a low frequency speaker configured to emit sound at frequencies of between 20 Hz and 200 Hz, wherein
the backrest comprises a rigid frame, a flexible suspension system, and upholstery, wherein the suspension system is suspended in the frame and covered by the upholstery such that, when an occupant is seated on the car seat, at least a portion of the upholstery is arranged between the suspension system and the occupant,
the low frequency speaker is arranged in the backrest and attached to the suspension system, and
the low frequency speaker is arranged on a backside of the suspension system that faces away from the seating area.

8. The car seat of claim 7, wherein the suspension system comprises at least one spring element.

9. The car seat of claim 7, wherein the low frequency speaker comprises a loudspeaker enclosure, and wherein the loudspeaker enclosure is attached to the suspension system.

10. The car seat of claim 7, wherein the backrest comprises a cavity adjacent to the suspension system towards a back side of the car seat, and wherein the low frequency speaker is at least partly arranged in the cavity between the suspension system and a backside of the backrest.

11. The car seat of claim 7, wherein the car seat is a driver's seat.

12. The car seat of claim 7, wherein the car seat is a front passenger seat including a seating area and a backrest.

13. The car seat of claim 7, wherein the low frequency speaker is arranged on the backside of the suspension system that faces away from the seating area.

14. A seat assembly comprising:
a car seat comprising a seating area and a backrest, wherein the seating area is arranged at a lower end of the backrest; and
a low frequency speaker configured to emit sound at frequencies within a predetermined frequency range, wherein
the backrest comprising a rigid frame, a flexible suspension system, and upholstery, wherein the suspension system is suspended in the frame and covered by the upholstery such that, when an occupant of a vehicle is seated on the car seat, at least a portion of the upholstery is arranged between the suspension system and the occupant,
the low frequency speaker is arranged in the backrest and attached to the suspension system, and
the low frequency speaker is arranged on a backside of the suspension system that faces away from the seating area.

15. The seat assembly of claim 14, wherein the suspension system comprises at least one spring element.

16. The seat assembly of claim 14, wherein the low frequency speaker comprises a loudspeaker enclosure, and wherein the loudspeaker enclosure is attached to the suspension system.

17. The seat assembly of claim 14, wherein the backrest comprises a cavity adjacent to the suspension system towards a back side of the car seat, and wherein the low frequency speaker is at least partly arranged in the cavity between the suspension system and a backside of the backrest.

18. The seat assembly of claim 14, wherein the car seat is a driver's seat.

19. The seat assembly of claim 14, wherein the car seat is a front passenger seat including a seating area and a backrest.

20. The seat assembly of claim 14, wherein the predetermined frequency range corresponds to a frequency range of between 20 Hz and 200 Hz.
